(19) United States
(12) Patent Application Publication
(10) Pub. No.: US 2009/0254408 A1
(43) Pub. Date: Oct. 8, 2009

(54) FACILITIES MONITORING SYSTEM WITH TELEPHONE INTERFACE AND AUTOMATIC PROBLEM VERIFICATION

(75) Inventor: Andrew H. McMillan, Manchester, NH (US)

Correspondence Address: SHEEHAN PHINNEY BASS & GREEN, PA;c/o PETER NIEVES, 1000 ELM STREET, MANCHESTER, NH, 03105-3701, US

(73) Assignee: Teletrol Systems Inc., Manchester, NH (US)

(21) Appl. No.: 12/419,913

(22) Filed: Apr. 7, 2009

Related U.S. Application Data
(60) Provisional application No. 61/040,355, filed on Apr. 7, 2008.

(51) Int. Cl. G06Q 10/00

(52) U.S. Cl. 705/9

(57) ABSTRACT

A building management system includes a telephony interface, by which a caller can enter information about a problem, thereby eliminating the need for a human operator. The building management system may also include components that enable the system to verify the condition reported by the caller. The building management system may also include a capability for storing sensor and other data automatically gathered from the building at the time the caller reports the problem. This “snapshot” can be used later by a service representative to diagnose the problem. Such a snapshot is particularly valuable when diagnosing a transient problem. In addition, the snapshot can be provided to a service bureau that is to handle the problem, thus giving the service bureau information relevant to the problem, without giving the service bureau access to all data collected by the building management system.

### CROSS-REFERENCE TO RELATED APPLICATION

This application claims priority to copending U.S. Provisional Application entitled, “Facilities Monitoring System with Telephone Interface and Automatic Problem Verification,” having Ser. No. 61/040,355, filed Apr. 7, 2008, which is entirely incorporated herein by reference.

### FIELD OF THE INVENTION

The present invention relates to automatic facilities monitoring systems and, more particularly, to such systems that can automatically verify problem reports including those reported by telephone.

### BACKGROUND OF THE INVENTION

Businesses of today employ many different types of systems that require monitoring and attention by responders. Building heating, air-conditioning and ventilation HVAC) systems, building lighting systems, computer systems, network systems, security systems, and the like, are able to police themselves for failures or out-of-limit conditions. For example, large buildings, such as retail stores, businesses, hotels, and others, typically employ energy management systems to control climate and lighting of the building. In addition, sophisticated energy management systems may be employed in groups of buildings and controlled from a central point, such as a headquarters building. In such a case, each building energy management system is connected to a central management system in the headquarters building via a communication network, such as a T1 or DSL line, a private local- or wide-area network or the Internet.

If one of these building management systems detects a failure (such as a failure of an air-conditioning unit) or an out-of-limit condition (such as an excessively high or low temperature on a retail store floor), the system notifies a service bureau or a central system. A person may or may not respond to the notification, which introduces an element of uncertainty to system response. In addition, the service bureau may dispatch a service representative to rectif the situation. It should be noted that such a service representative may be internal to the building of concern(or associated company) or external to the building of concern.

Some management systems automatically notify one or more service representatives directly. In one such system, web servers connected to the management systems post information, such as information about alarms that are raised by the management systems. Service representatives who are on call and responsible for responding to particular types of situations subscribe to web feeds that are provided by the web servers. Each service representative carries a portable electronic device, such as a mobile phone, wireless PDA, or laptop computer with wireless networking. When a change in the state of an alarm condition occurs, each service representative that subscribed to that particular condition is notified. In particular, an aggregator in the service representative's portable electronic device notifies the service representative. Such a system is described by commonly-owned U.S. patent application Ser. No. 11/445,904, titled “Distribution of System Status Information Using a Web Feed,” filed Jun. 2, 2006.

Despite the presence and operation of systems that detect failures and out-of-limit conditions, automatically notify service representatives, and if permitted, dispatch service representatives, people who occupy buildings often detect real or imagined situations that they believe should be rectified, but that are not being addressed or that may not have been detected by the automated systems. For example, a retail store manager who notices that the store is uncomfortably warm or cold, or who is so told by a customer, may wish to ensure that a service representative promptly addresses the issue. The manager may be hesitant to rely on the automated system, or the manager may wish to personally report the problem and, therefore, appear responsive to the customer. Similarly, an employee in an office building may believe the office temperature is inappropriate and wish to report the problem.

With prior-art systems, the manager or employee may have a telephone number of a building management organization or a service bureau. In either case, the manager or employee is limited to placing a telephone call to a human operator. The human operator may enter information into a system, which then contacts a service representative. However, such a scenario interposes a human operator into the communication chain, which delays notifying the service representative and introduces a possibility of inexactly conveying the message of the caller to the service representative. Furthermore, the human operator has no automatic way to verify the accuracy of the information from the caller, such as, whether the problem reported by the caller is real or imagined.

Thus, a heretofore unaddressed need exists in the industry to address the aforementioned deficiencies and inadequacies.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating an environment in which the present system and method can be used.

FIGS. 2-4 contain a flowchart of a portion of an exemplary voice interface call flow, in accordance with an exemplary embodiment of the invention.

FIG. 5 is a block diagram of a building, and an energy management system therein, in accordance with an alternative embodiment of the invention.

FIG. 6 is a flowchart of operations performed by a central energy management system connected to the energy management system of FIG. 5.

FIG. 7 is a block diagram showing a central energy management system, in accordance with yet another embodiment of the present invention.

### DETAILED DESCRIPTION

In accordance with principles of the present invention, a building energy management system includes a telephony interface, by which a caller can enter information about a problem, thereby eliminating the need for a human operator. The building energy management system may also include components that enable the system to verify the condition reported by the caller, after which feedback may be provided to the caller. The building energy management system may also include a capability for storing sensor and other data automatically gathered from the building at the time the caller reports the problem. In addition, if the system and caller do not agree upon conditions, the system may allow for escalation of the problem to allow for a service representative to be notified for handling of the problem. The “snapshot” of sensor and other data can be used later by a service representative to diagnose the problem. Such a snapshot is particularly valuable when diagnosing a transient problem. In addition, the snapshot can be provided to a service bureau that is to handle the problem, thus giving the service bureau information relevant to the problem, without giving the service bureau access to all data collected by the building energy management system.

The disclosed system can, but need not, automatically notify service representatives using web feeds, as disclosed in the above-referenced U.S. patent application Ser. No. 11/445,904, the contents of which are hereby incorporated by reference in their entirety. Web feeds provide web contents and/or summaries of web contents together with links to full versions of the contents and, optionally, other metadata. Known web feed protocols for producing such web feeds include, but are not limited to, RSS and ATOM. RSS, for example, delivers web information as an XML file called an RSS feed or RSS channel. Users subscribe to the Really Simple Syndication (RSS) channel to view the RSS feed via a client aggregator. An aggregator may be a stand-alone software application or an application built into a web browser. An aggregator can be implemented in a laptop computer, cellular telephone, PDA or other suitable portable or non-portable device. The aggregator updates a user's display with new RSS feed information, when the information becomes available.

Although the following exemplary embodiment is described in the context of a building energy management system, other types of property and equipment can be monitored, and users or nonusers of the property or equipment can call the system to report problems. For example, a person can call the system to report a problem with an office desktop computer or a computer network. A person can also call the system to report a problem with an out-of-order municipal parking meter, rapid transit system, wired or wireless telephone service, cable television service or any other type of property, equipment or service (collectively “equipment”) that potentially requires a responder to attend to a change in a status of the equipment. It should be noted that, in order to attend to the problem, the responder may not necessarily have to go to the same location as the caller.

In addition to the abovementioned, it should be noted that the system need not use Web feeds for automatic notification. Instead, the system may use any means of communication such as, but not limited to, a telephone, a pager, a facsimile machine, or electronic mail.

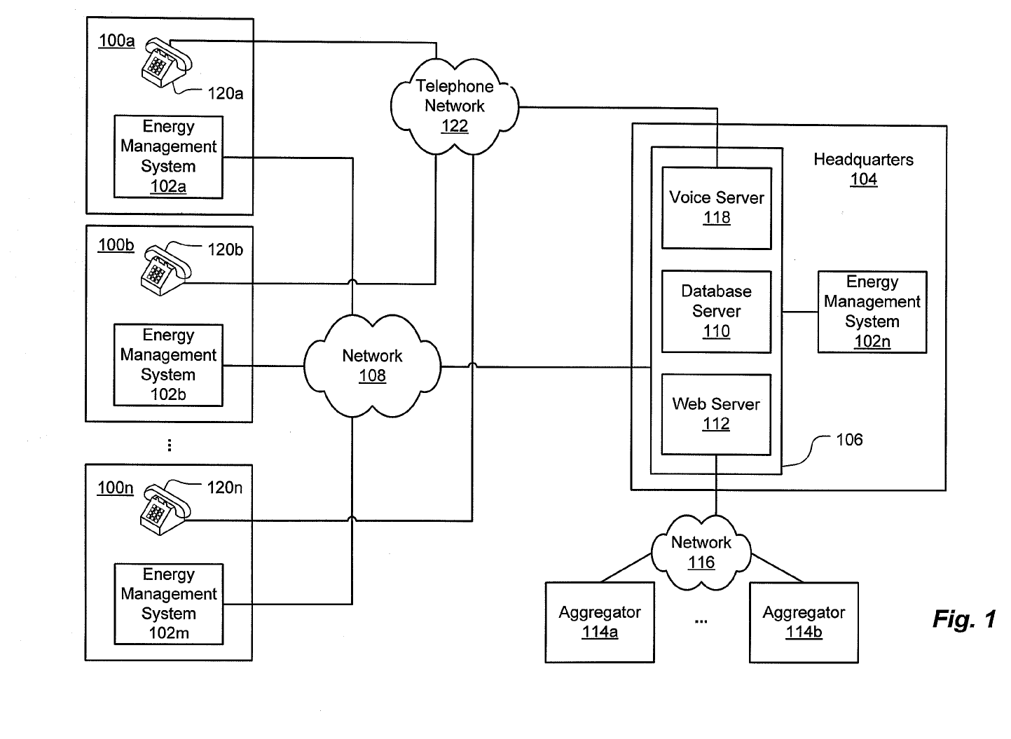

As noted, the exemplary embodiment is described in the context of a building energy management system. As is known to those having ordinary skill in the art, a building energy management system includes building automation components that allow for control of things such as, but not limited to, lighting, heating, ventilation, and air conditioning. FIG. 1 is a block diagram of such a context. Buildings 100a, 100b and 100n employ corresponding building energy management systems 102a, 102b and 102n, which automate climate control, lighting, and/or building security, etc., for their respective buildings 100a-n.

A headquarters building 104 employs its own building energy management system 102n, as well as a central energy management system 106, from which all the other building energy management systems 102a-m can be controlled. The individual building energy management systems 102a-m are coupled to the central energy management system 106 via a network 108 or, as may be the case for the headquarters building energy management system 102n, a direct connection. The network 108 or the direct connection can be a private local area network (LAN), a private wide area network (WAN), a portion of the Internet, a T1 or DSL line, and ATM network or any other suitable network or line.

For each building 100a-n and 104, the respective building energy management system 102a-n controls building systems, such as in response to pre-programmed settings, or settings provided by a user via interactions with the energy management system 102a-n or with the central energy management system 106. Each building energy management system 102a-n monitors building systems and sensors (such as light and temperature) to ensure the building systems and sensors operate properly. If one of the building energy management systems 102a-n detects a system or sensor failure or an out-of-limit condition that does not respond to attempts by the energy management system 102a-n to automatically control it, the energy management system 102a-n generates an alarm related to the detected condition. The alarm is sent to the central energy management system 106, either directly, or via the network 108.

To facilitate storing information about the state of the energy management system 102a-m, the central energy management system 106 includes a database server 110. To facilitate presenting this information to headquarters personnel, the central energy management system 106 also includes a web server 112. These servers 110 and 112 may reside in separate computers, or they may reside in a single computer. The web server 112 is also used by the central energy management system 106 to communicate status information (particularly changes in status information) to service representatives, who are responsible for correcting problems.

If the central energy management system 106 receives an alarm from one of the building energy management systems 102a-m, the central energy management system 106 updates the database server 110 as necessary. In addition, the web server 112 can display information related to the alarm condition on a computer screen (not shown). Thus, if a service representative happens to be present at the headquarters building 104 and observes the alarm display, the service representative can respond to the alarm.

However, one or more service representatives may have portable electronic devices, such as cell phones or (typically wireless) Personal Digital Assistants (PDAs) or laptop PCs, that are equipped with aggregators 114a and 114b. Using the aggregators 114a-b, the service representatives can selectively subscribe to web feed(s) provided by the web server 112. Each of the web feeds can represent a different building 100a-m, a different type of situation that may arise in one or more of the buildings 100a-m, another type of change that may occur in a parameter or value stored in the database server 110 and that should be responded to, or any combination thereof Thus, individual service representatives may subscribe to different web feeds, based on the types of problems the service representatives are trained or contracted to respond to. Similarly, the service representatives can subscribe to the web feeds at the beginnings of their shifts and unsubscribe from the web feeds at the ends of their shifts or if the service representatives become engaged in a project that cannot be interrupted. Consequently, only available, on-duty service representatives are notified.

In accordance with an alternative embodiment of the invention, if no one is subscribed to a specific building, the central energy management system 106 may create a message to headquarters personnel that there is an unsubscribed Web feed. Thereafter, the personnel may contact a service representative to assign to the Web feed.

A network 116 is used by the aggregators 114 to subscribe to the web feeds and to receive updated information from the web server 112 as needed. The network 116 can be the Internet, a private wired or wireless network, a cellular telephone network or any other suitable network or combination thereof.

### Telephony Interface

As noted, a person in one of the buildings 100a-m may detect a problem and wish to make the problem known, so that the problem may be rectified. In most cases, the only interface available to the person is a telephone. To facilitate receiving problem reports via telephone, without requiring a human operator, the central energy management system 106 includes a voice server 118. Thus, persons in the buildings 100a-n can use local telephones 120a-n to call the voice server 118 via a telephone network 122. The headquarters building 104 may also include telephones (not shown), over which the voice server 118 can be called. In fact, any telephone in the world can be used to call the voice server 118. It should also be noted that instead of a telephone, the person reporting the problem may report the problem by texting (i.e., electronically sending a text message) the problem to the central energy management system 106.

The voice server 118 includes well-known hardware and software to implement an interactive voice response (IVR), voice browser, or other like system, to provide a voice interface between telephone callers and the central energy management system 106. For example, the voice server 118 can include a voice browser that presents interface pages to the callers. These pages (“voice pages”) are written in VoiceXML or another suitable voice dialog markup language.

The voice interface provided by the voice server 118 enables a caller to enter information that describes the problem. For example, the voice interface enables the caller to enter the location of the problem (such as a particular facility, building, system, parking meter, train car, etc.) and the nature of the problem (such as an uncomfortable temperature, inoperative computer, dangerous situation, etc.). In addition, caller ID may be used to determine location of the problem.

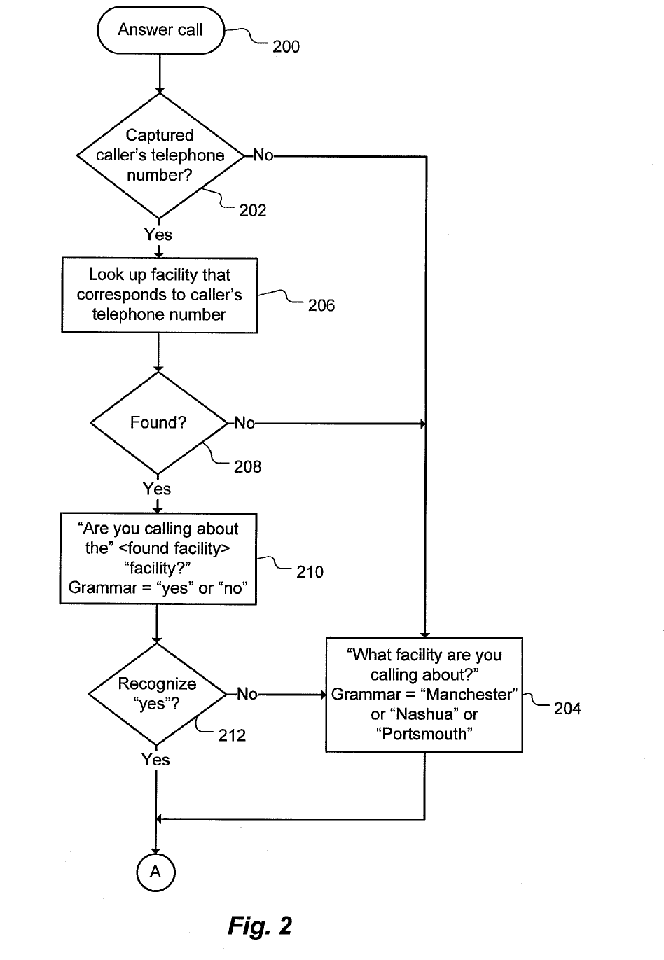

The flowchart spanning FIGS. 2-4 is a portion of an exemplary voice interface call flow that can be provided by the voice server 118. It should be noted that any process descriptions or blocks in flow charts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

As shown by block 200, the voice server 118 answers a call. If the voice server 118 is able to ascertain the caller's telephone number, such as by using a caller ID, automatic number identification (ANI) service or other system or service, the voice server 118 may be able to automatically ascertain the building 100a-n, from which the caller is calling. However, if the caller's telephone number is not captured, the voice server 118 prompts the caller to identify the facility where the problem exists. As shown by block 202, control is transferred based on whether the voice server 118 successfully ascertains the caller's telephone number.

If the voice server 118 cannot ascertain the caller's telephone number, the voice server 118 prompts the caller to identify a facility, about which the caller is calling (block 204). The voice server 118 can include an automatic speech recognition (ASR) system to recognize the caller's utterances. A suitable ASR system is available from Nuance Communications, Inc., of Burlington, Mass. 01803. If the voice server 118 includes an automatic speech recognizer, the voice pages have associated grammars that identify acceptable caller utterances. For example, voice server 118 can prompt the caller to utter the name of the facility. In this case, the grammar includes the names of facilities handled by the system, as well as variations on their names, nicknames and the like.

Whether or not the voice server 118 includes an automatic speech recognizer, the voice server 118 can include a dual-tone multi-frequency (DTMF) detector to detect telephone key presses by the user. Many automatic speech recognition systems include DTMF detection capabilities. Thus, rather than uttering the name of a building, each building 100a-m can be assigned a numeric or alphanumeric code, and the caller can enter this code using the keypad on the caller's telephone.

Alternatively or in addition, the voice server 118 can play a menu prompt to the caller, in which each building 100a-n is assigned a code. (For example, “Press 1 for Manchester, press 2 for Nashua or press 3 for Portsmouth.”) The prompt can be stored as recorded audio, or the prompt can be generated by a speech synthesizer (text-to-speech engine), or a combination of the two approaches can be taken. The caller responds to the prompt by pressing one or more keys on the telephone keypad to enter the code associated with the building 100a-m about which the caller is calling. If there is a large number of buildings 100a-m, the prompt menu can be hierarchical. That is, the voice server 118 may first ask the caller to select a geographic region. The voice server 118 then plays another prompt menu that lists buildings only in the selected region and asks the caller to select a building from the list.

Referring back to block 202, if the voice server 118 is able to ascertain the caller's telephone number, as shown by block 206, the voice server 118 looks up the caller's telephone number to ascertain the building 100a-n, from which the caller is calling. For example, a table or 20 database that correlates telephone numbers (or portions thereof, such as area codes, exchanges, etc.) with buildings can be used. As shown by block 208, if a building is found to correspond with the caller's telephone number, the voice server 118 acts as described by block 210. However, if no corresponding building is found, the voice server 118 prompts the caller to identify the building, as described above (block 204).

As shown by block 210, the voice server 118 prompts the caller to verify the building that the voice server 118 automatically correlated with the caller's telephone number. As shown by block 212, a determination is then made as to whether the recognized building is correct. If the caller indicates that the automatically identified building is incorrect, the functionality of block 204 is completed, and the voice server 118 prompts the caller to identify the building.

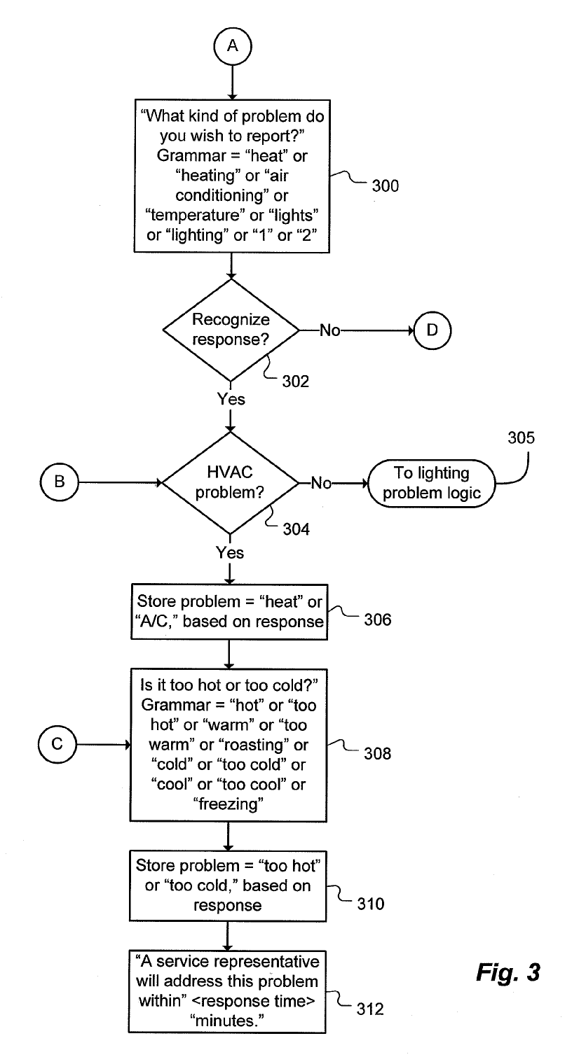

Referring to FIG. 3, which is a continuation of FIG. 2, once the building has been identified, the voice server 118 prompts the caller to identify the general type, i.e. broad category, of problem, such as HVAC or lighting (block 300). A determination is then made as to whether the response of the caller is recognized (block 302). If the caller's response is recognized, a determination is made as to whether the problem is an HVAC problem (block 304). If the problem is not an HVAC problem, a determination can be made regarding whether the problem relates to another issue, such as, but not limited to, lighting (block 305).

As shown by block 306, if the problem is an HVAC problem, the voice server 118 stores information in the database server 110 to indicate the general category of the problem. As shown by block 308, the voice server 118 then prompts the caller to provide more detail(s) about the problem. As shown by block 310, the voice server 118 then stores the additional detail(s) in the database server 110. Optionally, as shown by block 312, the voice server 118 may calculate an expected response time and report this expected response time to the caller.

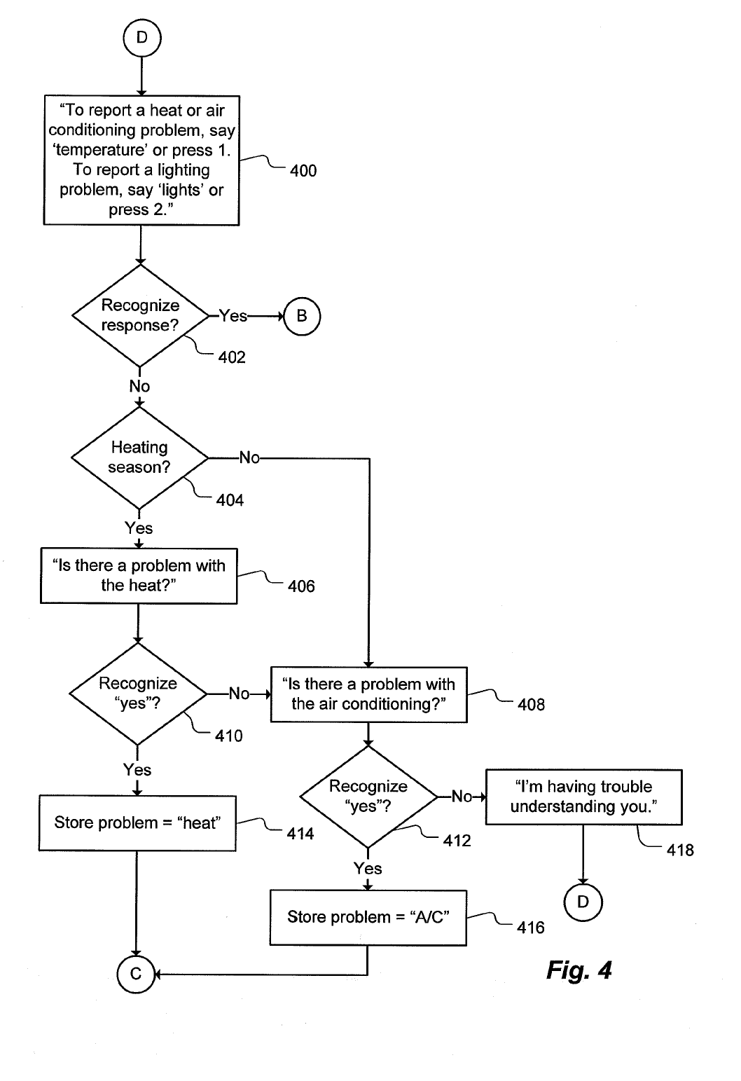

Returning to decision block 302, if the caller's response is not recognized, control passes to a portion of the call flow (FIG. 4) that determines the problem with a series of prompts and caller responses. For example, as shown by block 400 of FIG. 4, the voice server 118 prompts the caller with a list of utterances the caller can make and, alternatively, keys the caller can press to identify the general type of problem. A determination is then made as to whether the response of the caller is recognized. If the caller's response is recognized, control returns to block 304 of FIG. 3.

On the other hand, if the caller's response is not recognized, a more fine-grain series of prompts and caller responses are begun to ascertain the general nature of the problem (block 404). The voice server 118 can ask questions based on information the voice server 118 has available, in an effort to narrow the range of possible problems. For example, as shown by block 404, if a heating system is expected to be operating at the current time of the year (season), the voice server 118 asks, “Is there a problem with the heat?” (block 406). On the other hand, if it is not currently the heating season, the voice server 118 asks, “Is there a problem with the air-conditioning?” (block 408). Based on the user's response, as shown by block 414 or 416, the voice server 118 stores (in the database server 10) either “heat” or “A/C” as a general indication of the problem. However, if the voice server 118 does not recognize the response of the user while checking the response (block 412), an error message is provided (block 418) and control is returned to the functionality of block 400.

For simplicity, other portions of the call flow are not shown, but designing an appropriate call flow is well within the capabilities of a skilled practitioner. In any case, once the voice server 118 enters information into the database server 110 to identify a problem, the central energy management system 106 posts a change on the web server 112, much the way the central energy management system 106 responds to problems automatically reported by one of the energy management systems 102a-n in one of the buildings 100a-n, 104. Once the change is posted on the web server 112, if any of the aggregators 114a, 114b subscribed to a web feed that encompasses the change, the aggregator(s) 114a, 114b displays information or otherwise notifies the corresponding service representative.

### Automatic Problem Verification

As noted, a problem perceived by a caller may not be an actual problem, from the perspective of a building energy management system. For example, a caller may believe that an office is too warm or too cold, however, the office temperature may be within specified limits. To avoid dispatching a service representative, when no service is actually required, the central energy management system 106 can optionally use on-site sensors to detect actual values of environmental parameters, such as temperature, light level or operational status of equipment. The central energy management system 106 then compares the sensor data to prescribed limits. If any (or a predetermined number) of the sensors' data is outside the prescribed limits, the central energy management system 106 notifies the service representative(s), as described above. One having ordinary skill in the art will appreciate that one of many different communication means may be used to notify the service representative(s) such as, but not limited to, electronic mail, telephone, and pager. However, if all or most of the sensor data is within the prescribed limits, the central energy management system 106 may contact the caller and, if requested by the caller, allow for escalation of the problem to allow for a service individual to be notified for handling of the problem.

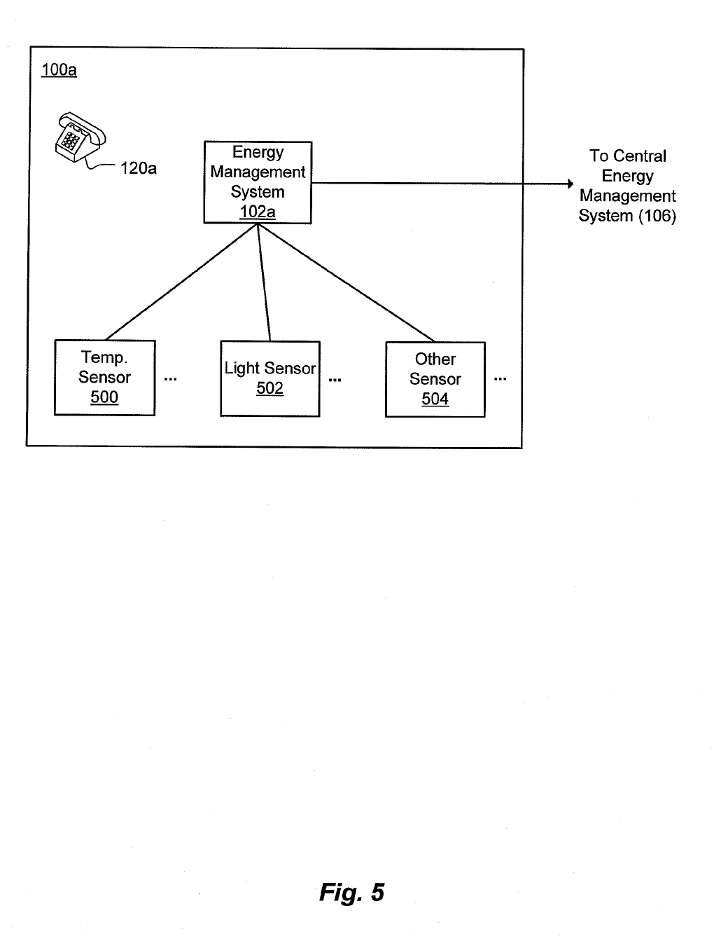

FIG. 5 will be used to describe an exemplary energy management system having sensors 500, 502, 504. FIG. 5 is a more detailed block diagram of one of the buildings (building 100a) of FIG. 1. The building 100a is equipped with a variety of sensors, such as temperature sensors 500, light level sensors 502 and/or other types of sensors 504, all coupled to the building energy management system 102a. Some or all of the sensors 500, 502, 504 can, but need not, be the same sensors as the building energy management system 102a uses to manage heat, air conditioning, lighting, etc. in the building 100a.

The other buildings 100b-m can be similarly configured; however, not all the buildings 100a-m need to be equipped with identical numbers or types of sensors. Furthermore, the sensors 500, 502, 504 need not all be within the building 100a. For example, some of the sensors 500, 502, 504 can be located outside the building 100a, such as in a parking lot or on a rooftop, to measure light, temperature, wind velocity, etc., for example.

As previously noted, the energy management system 102a is coupled to the central energy management system 106 via the network 108 (not shown in FIG. 5). The central energy management system 106 can query the sensors 500, 502, 504 by sending a request, via the network 108, to the energy management system 102a in the building 100a. The building energy management system 102a collects data from the sensors 500, 502, 504 and sends the requested data to the central energy management system 106, which ascertains whether the reported problem is actionable.

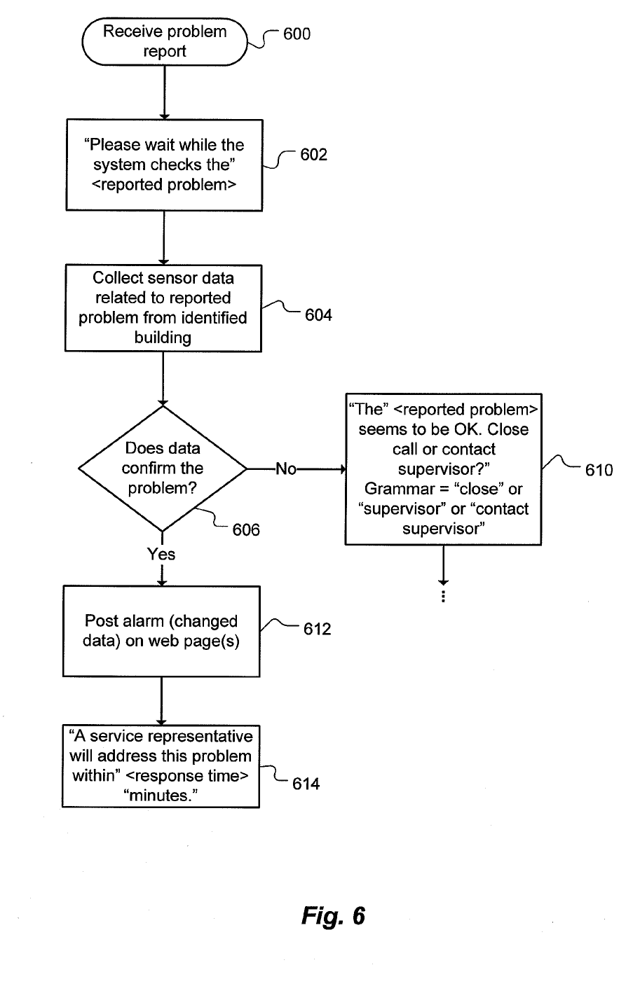

FIG. 6 is a flowchart of operations performed by the present system. As shown by block 600, a problem report is received, such as is described with reference to FIGS. 2-4. However, before information about the reported problem is posted on the web server 112 (to trigger the above-described web feeds), data from an appropriate one or more of the sensors 500, 502, 504 is gathered and analyzed. As shown by block 602, the voice server 118 can prepare the caller to wait while the data is gathered and analyzed. For example, the voice server 118 can prompt the caller to, “Please wait until the system checks the air-conditioning problem.”

As shown by block 604, the sensor data is gathered and analyzed. For example, if the caller reported an HVAC problem, data from the temperature sensors 500 in the building 100a is gathered and compared to predetermined upper and lower limits. If the caller's location can be ascertained more precisely than simply the building 100a, then the temperature in the vicinity of the caller is used. In either case, as shown by block 606, if the data confirms the reported problem, the alarm is posted to the web server 112 (block 612). For example, if the caller reported an air-conditioning problem, and the temperature in the vicinity of the caller is found to exceed the predetermined upper limit, an alarm is posted. Optionally, as shown by block 614, the voice server 118 calculates an expected response time and reports this expected response time to the caller. This prompt also confirms to the caller that the reported problem has been entered into the system.

On the other hand, if when checking (block 606), the data does not confirm the reported problem, the voice server 118 reports to the caller that the problem could not be confirmed (block 610). In addition, the voice server 118 can give the caller an option to either close the call or contact the caller's supervisor (such as in the case of the store manager calling to report a HVAC problem). Further, the voice server 118 may contact the caller and, if requested by the caller, allow for escalation of the problem to allow for a service individual to be notified for handling of the problem.

Thus, the system can filter reported problems based on actual data. The system can respond to reported problems that are confirmed, and the system can further address problem reports that cannot be confirmed.

It should be noted, that in accordance with an alternative embodiment of the invention, the system may provide an auto verification feature that may be utilized prior to payment of a dispatched service individual. Specifically, after receiving a report from a dispatched service individual stating that a reported problem has been serviced, the system may query the sensors to determine if the reported problem has actually been serviced. This verification preferably would take place prior to providing payment to the service individual for the service call.

### Data Snapshots and Web “Microsite”

A potentially large number of service bureaus may be involved in providing repair and other types of services to a single building or to a number of buildings. For example, a large, national department store chain may contract several service bureaus, each servicing a different geographic area. In addition, different service bureaus may handle different types of problems. In any case, the database server 110 and the web server 112 store a potentially large amount of data It may be desirable to limit the amount of data that is made available to a service bureau or to a service representative. For example, it may be desirable to make available only data that is relevant to a problem that the service bureau or representative is to handle.

Limiting the amount of data that is made available to a service bureau or representative removes potential sources of confusion that may result from overwhelming the service bureau or representative with irrelevant data. In addition, security concerns may be addressed by providing data to the service bureaus or representatives strictly on a need-to-know basis. In addition, as previously noted, a snapshot of transient data may assist the service representative in diagnosing a problem, particularly a transient problem.

In FIG. 1, the web server 112 is shown providing web feeds to one or more aggregators 114a, 114b. The web server 112 can also serve web pages to service bureau personnel as well as to headquarters personnel. Thus, the web server 112 serves user communities both outside and inside the organization that owns the buildings 100a-n and 104.

To control the amount of data provided or made available outside the organization that owns the buildings 100a-n and 104, two or more sets of web pages can be made available. One of these sets of web pages can contain all the data that is available about the energy management systems 102a-n. Each of the other sets of web pages can contain a different (possibly overlapping) subset of the data and provide corresponding web feeds. Thus, each service bureau, or each service representative, can be given access to a different set of web pages and respective web feeds. In this way, the data stored in the database server 110 and the web server 112 can be effectively partitioned, so that each recipient receives only the data that he/she needs or is authorized to receive.

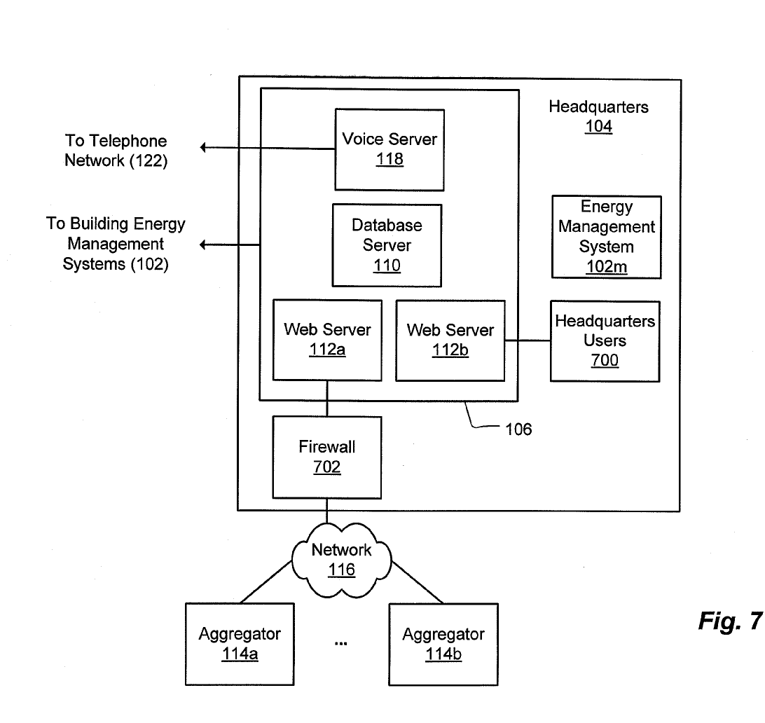

In one embodiment, shown in FIG. 7, two separate web servers 112a, 112b serve the user communities respectively outside and inside the organization that owns the buildings 100a-n, 104. One of the web servers 112b serves the user community inside the organization, such as headquarters users 700. This web server 112b is typically connected to a headquarters network i.e. the web server 112b is connected on the inward-facing side of a firewall 702 that protects the web server 112b, the database server 110 and other systems connected to a headquarters network. As noted, the network 116 may be the Internet or another public network. Even if the network 116 is a private network, the firewall 702 protects the headquarters network and its systems from malicious or faulty systems connected to the network 116.

The other of the two web servers 112a serves the user community outside the organization, i.e. the service bureaus and/or the service representatives. This web server 112a can be located outside the firewall 702. In one such implementation, the web server 112a is placed in a “demilitarized zone” that is maintained by a router (not shown) that connects the headquarters network to the network 116. This arrangement provides a service bureau and/or service representatives with access to selected data and selected web feeds, without exposing all the data in the database server 110.

If it is desirable to provide multiple service bureaus or groups of service representatives with different subsets of data and/or different web feeds, web pages and web feeds provided by the web server 112a can be kept distinct by use of different domains, different subdomains or other well-known techniques. Alternatively, separate web servers (not shown) can be substituted for the web server 112a, and each of the separate web servers can serve a set of users having access to a common set of data and web feeds.

Each of the separate web servers can be implemented on a distinct computer, or several of the web servers can be implemented on a single computer, such as by using “virtual hosts.” The term virtual host refers to a practice of maintaining more than one server on one computer, as differentiated by their apparent hostnames. Virtual hosts can be implemented with the Apache HTTP server, which is available from The Apache Software Foundation, http://www.apache.org.

Regardless of whether the web pages and web feeds are kept distinct through use of different domains, different subdomains, separate web servers or by another mechanism, each apparent web site that is made available to a group of users having access to a common set of data and/or web feeds is referred to herein as a “microsite.” When an alarm is raised, data related to the alarm is moved to the appropriate microsite, so that the appropriate service bureau(s) and or service representative(s) may access the data and/or receive the data, and/or receive a link to the same, via a web feed, a telephone, a pager, a facsimile machine, electronic mail, or any means of communication.

Typically, the database server 110 and the web server 112b contain current data about the states of the energy management systems 102a-n. However, when diagnosing a problem, it is often helpful to have access to historical data, such as data that was captured at the time the problem was detected. It may also be helpful to have access to data that was captured before and/or after the problem was detected. In other words, it is sometimes useful to have access to one or more snapshots of the data. The snapshots can be thought of as analogous to a series of frames of a motion picture taken around the time the problem was detected.

Optionally, to provide such historical data, the central energy management system 106 stores data collected from the building energy management systems 102a-m for a predetermined amount of time, such as 30 minutes, such as in a circular buffer. If no problem is detected within the predetermined amount of time, the central energy management system 106 can flush the older data. Thus, the central energy management system 106 always has data for at least the past 30 minutes.

If a problem is detected, the central energy management system 106 moves the historical data to the appropriate microsite. In addition, the central energy management system 106 continues to capture data and move it to the microsite as long as the problem exists. Optionally, the central energy management system 106 continues to capture data and move it to the microsite for a predetermined amount of time after the problem ceases to be detected.

The above-described procedure of capturing data before, during and/or after a problem is detected can also be used to capture data before, during and/or after a measured parameter is anomalous, i.e. outside of a predetermined limit, but not sufficiently anomalous to raise an alarm. Thus, data can be captured for a device, such as a cooling tower in a multi-stage cooling system, in anticipation of a future failure.

Each of the components of the central energy management system 106 can be implemented on a separate computer, which includes a memory and a processor. Alternatively, several of the components of the central energy management system 106 can be implemented on a single computer.

Each processor is controlled by instructions stored in a memory. Some of the functions performed by the central energy management system 106 have been described with reference to flowcharts. Those skilled in the art should readily appreciate that functions, operations, decisions, etc. of all or a portion of each block, or a combination of blocks, of the flowcharts can be implemented as computer program instructions, software, hardware, firmware or combinations thereof Those skilled in the art should also readily appreciate that instructions or programs defining the functions of the present invention can be delivered to a processor in many forms, including, but not limited to, information permanently stored on non-writable storage media (e.g. read only memory devices within a computer, such as ROM, or devices readable by a computer I/O attachment, such as CD-ROM disks), information alterably stored on writable storage media (e.g. floppy disks and hard drives) or information conveyed to a computer through communication media, including computer networks. In addition, while the invention may be embodied in software, the functions necessary to implement the invention may alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. Moreover, while the preferred embodiments are described in connection with various illustrative data structures, one skilled in the art will recognize that the system may be embodied using a variety of data structures. Accordingly, the invention should not be viewed as limited, except by the scope and spirit of the appended claims.

What is claimed is:

1. A method for monitoring a system, comprising the steps of:
receiving a problem report related to the system;
determining a building from which said problem report is derived;
storing said problem report; and
automatically determining if said problem report is accurate.

2. The method of claim 1, wherein the problem is provided by a human caller via a telephone

3. The method of claim 2, wherein the step of receiving the problem report further comprises automatically recognizing an utterance conveyed via the telephone from the caller and related to the problem.

4. The method of claim 2, wherein the step of receiving the problem report comprises automatically detecting a signal derived from a telephone key pressed by the caller.

5. The method of claim 2, wherein the step of receiving the problem report further comprises the steps of:
automatically identifying a telephone number of the caller; and
identifying a potential location of the problem based on the caller's telephone number.

6. The method of claim 2, wherein the step of receiving the problem report further comprises automatically recognizing an utterance by the caller identifying a location of the problem.

7. The method of claim 2, wherein the step of receiving the problem report further comprises automatically recognizing an utterance by the caller identifying a category of the problem.

8. The method of claim 7, wherein the category of the problem is one of the group consisting of an incorrect temperature within at least a portion of a building and an incorrect lighting level within at least a portion of a building.

9. The method of claim 2, further comprising the step of maintaining a plurality of microsites and selecting one of the plurality of microsites based on an attribute of the reported problem.

10. The method of claim 8, further comprising the step of, in response to receiving the problem report, storing, on the selected microsite, data related to the problem and collected over a period of time spanning the problem report.

11. The method of claim 9, further comprising the steps of:
automatically collecting data related to the reported problem; and
if the collected data meets at least one predetermined criterion, storing, on the selected microsite, data related to the problem and collected over a period of time spanning the problem report.

12. The method of claim 2, wherein if the problem report is not accurate, said method further comprises the steps of:
providing the human caller with an option to escalate the urgency of the problem; and
dispatching a service provider to address the problem if the human caller chooses to escalate the urgency of the problem.

13. The method of claim 2, further comprising the step of contacting the caller and, if requested by the caller, allowing for escalation of a problem associated with the problem report.

14. The method of claim 1, further comprising the step of calculating expected response time and reporting said response time to said caller.
